(19) United States
(12) Patent Application Publication
(10) Pub. No.: US 2020/0182389 A1
(43) Pub. Date: Jun. 11, 2020

(54) COUPLING FOR CRYOGENIC LIQUEFIED MEDIA

(71) Applicant: MESSER FRANCE S.A.S., Suresnes Cedex (FR)

(72) Inventor: Émilien FRÈRE, Meaux (FR)

(73) Assignee: MESSER FRANCE S.A.S., Suresnes Cedex (FR)

(21) Appl. No.: 16/618,615

(22) PCT Filed: May 4, 2018
(86) PCT No.: PCT/EP2018/061560

§ 371 Date: Dec. 2, 2019

(30) Foreign Application Priority Data
Jun. 13, 2017 (DE) 10 2017 005 588.2

(51) Int. Cl. F16L 37/36; F16K 15/06

(52) U.S. Cl. CPC F16L 37/36; F16L 37/248; F16K 15/063

(57) ABSTRACT

The invention relates to a coupling for cryogenic liquefied media, said coupling comprising a coupling socket (10) and a coupling connector (30), which can be connected thereto, each being equipped with a non-return valve (15, 40). According to the invention, the coupling socket (10) comprises a front section (11), having means for connecting to the coupling connector (30), and a rear section (12), having the non-return valve (15). According to the invention, the front section (11) is connected to the rear section (12) by means of screws (33) having predetermined breaking points, which break upon exceeding a specified tensile stress. According to the invention, the sections (11, 12) separate from each other and the non-return valves (15, 40) automatically move to the closed position.

The invention relates to a coupling for cryogenic liquefied media for connecting fluid-carrying lines, having a coupling socket and a coupling connector, which are each equipped with a check valve, which, in the uncoupled state, seals off a through flow opening arranged in the respective coupling part against the penetration of ambient air but automatically opens it during connection, wherein the coupling socket comprises a front section, having means for connection to the coupling connector, and a rear section, having the check valve, and the front section is connected to the rear section firmly but in a manner which allows release when a predetermined tensile stress is applied.

Couplings for connecting lines for cryogenically liquefied media are known. Couplings of this kind are used especially when fixed tank installations are filled with cryogenic media from a tanker vehicle.

U.S. Pat. No. 4,335,747 A1 describes a coupling having a coupling connector and a coupling socket, which are each equipped with a ball valve at the end and are connected to one another by means of bolts. Here, the coupling process takes place in the two working steps of sealing with respect to the outside and connecting the through flow devices. In this arrangement, however, separate shutoff valves for the through flow lines are required. In addition, there is the fact that the ball valves are not vacuum-insulated and cryogenic liquid escaping during uncoupling leads to freezing of the ball valves. The couplings described in DE 41 04 711 A1 and DE 42 19 912 A1 are constructed on a principle similar to the subject matter of U.S. Pat. No. 4,335,747 A1.

The subject matter of DE 195 16 029 C1 is a coupling for cryogenic liquefied media, in which vacuum-insulated line ends are connected to one another by means of a coupling connector and a coupling socket. At their ends, the line ends have axially movable sealing means, which, when the coupling is separated, are each moved by a spring into a position in which they seal off the respective line end against penetration by ambient air. When the coupling connector is introduced into the coupling socket, the sealing means are automatically moved into their respective open position against the force of the spring. This opens up a flow path through the two coupling parts which is sealed and insulated with respect to the outside. In order to create a permanent connection, the coupling parts are screwed together by means of a union nut. In the case of this subject matter, icing of the line ends in the uncoupled state is avoided, just as icing of the coupling is avoided during operation.

The subject matter of US 2006/278839 A1 comprises a coupling for fluid media having a coupling connector and a coupling socket. The coupling socket, for its part, is divided into two parts, which are connected to one another by means of a clamping ring. The clamping ring has one or more predetermined breaking points, at which the coupling socket is divided into two parts in the event of use. The flow connection in the coupling connector is automatically interrupted at the same time as the coupling socket is broken.

The known couplings have the disadvantage that, when subjected to severe tensile stress due to malfunctioning, they are secured only inadequately, for example if, on completion of a filling process from a tanker vehicle, the coupling has inadvertently not been released and the tanker vehicle is moved while the line is connected. In these cases, the coupling and/or the pipe or hose sections of the line may be broken, thus leading to an uncontrolled discharge of cryogenic liquid. Although the lines can be secured by separate check valves, these lead to an additional flow resistance, which reduces the flow of cryogenic medium and increases the duration of filling.

EP 2 781 818 A1 discloses a coupling for cryogenic liquefied media for connecting fluid-carrying lines, having a coupling socket and a coupling connector, which are each equipped with a check valve. When the coupling connector and the coupling socket are connected, the check valves move each other into an open position and thus allow the cryogenic medium to flow through. The coupling socket comprises a front section, to be connected to the coupling connector, and a rear section having the check valve, wherein the front section is connected firmly to the rear section by means of a permanent magnet in the normal operating state. When a tensile stress that exceeds the holding force of the permanent magnet is exceeded, the two parts of the coupling socket separate and, at the same time, the check valves move automatically into their closed position.

In the case of this subject matter, the parts of the coupling are separated from one another without destruction in the event of emergency cutoff, and can be subsequently joined together again without problems. However, this system is suitable only for means of securing against relatively weak tensile stresses; handling of permanent magnets which are designed for high tensile stress and have a correspondingly powerful holding force proves to be very difficult, especially when reattaching the coupling parts. Moreover, the magnetic field emanating from such a powerful permanent magnet can disrupt electronic systems in the vicinity.

The problem addressed by the present invention is therefore that of providing a coupling for cryogenic media which offers effective protection against the separation of the line and, at the same time, allows rapid filling and which can be handled without problems, even when designed for high tensile stresses.

According to the invention, this problem is solved by a coupling having the features presented in claim 1. Advantageous developments of the invention are indicated in the dependent claims.

In contrast to prior art couplings which are constructed from two coupling parts that can be connected firmly to one another, namely a coupling socket and a coupling connector, the coupling according to the invention has a three-part construction by virtue of the separability of the front and rear sections of the coupling socket. The front and rear sections of the coupling socket are designed in such a way that they separate from one another at a predetermined tensile stress, whereupon the check valves in the coupling socket and the coupling connector move automatically into their respective closed position. According to the invention, this is achieved by virtue of the fact that the front and rear sections of the coupling socket are each firmly connected to one another by connecting means which have a predetermined breaking point. The connecting means connect the sections directly to one another and are chosen in such a way that the axial limiting stress at which the predetermined breaking point breaks corresponds to the required maximum tensile stress. With the destruction of the connecting means, the sections of the coupling socket separate from one another, and the check valves move automatically into their closed position. In this way, the uncontrolled outflow of cryogenic medium is prevented in an effective manner. Here, the limit value of the tensile stress, above which the front section separates from the rear section of the coupling socket as intended, is chosen in accordance with the circumstances and, in particular, must be lower than the tensile strength of the other components of the coupling or of the line connected thereto but sufficiently large to be able to withstand customary loads occurring during a normal filling process. The coupling according to the invention is particularly suitable for the production of a flow connection between two lines for liquid nitrogen or for some other cryogenically liquefied gas, e.g. liquefied inert gas or natural gas. In particular, the coupling according to the invention is suitable as a quick action coupling for filling a refrigerated vehicle equipped with a reservoir for a cryogenically liquefied medium from a fixed storage tank since, by virtue of its simple construction having only a small number of flow resistances, it allows quick and uncomplicated connection of the lines and rapid filling and yet offers a high degree of protection against uncontrolled escape of cryogenic liquid.

As compared with connection using a permanent magnet, the present invention has the advantage that even couplings with a high required tensile stress after the occurrence of an occasion of use, that is to say in which the two sections of the coupling socket have been released from one another owing to the exceeding of the maximum tensile stress, can be joined together again without problems. In this case, all that is required is to remove the remains of the broken connecting means and replace them with new connecting means.

A particularly preferred embodiment of the invention envisages that the front section is connected to the rear section by means of screws which each have a predetermined breaking point. The screws are passed through holes in a flange of a section of the coupling socket and are screwed into an internally threaded hole in a flange of the other section of the coupling socket. As preferred connecting means between the two sections of the coupling socket, use is thus made of special screws which have a predetermined breaking point, e.g. a section with a reduced diameter, at which the screws break when a predetermined maximum axial tensile stress (limit load) is applied. A plurality of screws, e.g. three to eight screws, is preferably arranged in a rotationally symmetrical manner at uniform angular intervals in the two flanges. This embodiment has the particular advantage that, when the requirements on the maximum tensile strength are changed, the screws can be exchanged without problems and replaced by screws with a correspondingly different limit load.

The means for connecting the front section of the coupling socket to the coupling connector preferably comprise a bayonet joint or a screwed joint, e.g. a union nut, which is screwed onto a thread formed on the outside of the coupling connector or the front section. In this way, the front section of the coupling socket and the coupling connector remain firmly connected to one another, even after the separation of the rear section.

The check valve of the coupling connector and the check valve of the coupling socket are preferably each equipped with an axially movable closing body, e.g. in the form of a disk or a ball, which can be moved counter to the action of a restoring force from a closed state, in which it seals off the through flow opening of the respective coupling part, into an open state, in which it exposes the through flow opening. In this case, the closing elements are configured in such a way that, during the connection of the coupling parts, they move each other into their respective open state and, in the process, expose a flow path between the lines which are connected to one another by the coupling. In contrast, during the separation of the coupling socket from the coupling connector, but also during the separation of the rear section from the front section of the coupling socket, the closing bodies move automatically into their respective closed state and thereby shut off the through flow openings of both coupling parts.

It is particularly expedient if a sealing element, e.g. a sealing ring, which ensures the gastightness of the coupling connection, is arranged on the front section and/or the rear section of the coupling socket. The sealing ring is preferably of temperature-stable design and is manufactured from PTFE, for example.

An advantageous embodiment of the invention envisages that the front section of the coupling socket is equipped with a shield to protect the coupling socket from mechanical effects. This shield is, for example, a metal or plastic sleeve, which is arranged concentrically around the connecting elements of the coupling socket with the coupling connector and protects the connecting elements against damage or contamination, e.g. in the event that the parts of the coupling socket separate from one another in the case of emergency triggering and the coupling socket falls to the ground, thus enabling rapid reconnection of the coupling socket and the coupling connector.

A likewise advantageous embodiment of the invention is characterized in that the coupling socket is rotatably connected to a line for a cryogenic medium. By means of such an embodiment, the invention takes account of the fact that, although lines for cryogenic media usually have a certain flexibility, they can twist upon themselves only with difficulty. Since rotation of the coupling socket and the coupling connector is unavoidable, at least in the case of a bayonet joint, the rotatable arrangement makes the handling of the coupling easier. For this purpose, for example, a connection stub connected firmly to a line for the cryogenic medium, e.g. by welding, brazing or screwing, is accommodated rotatably in the housing of the coupling socket or of the coupling connector.

Illustrative embodiments of the invention will be explained in greater detail below with reference to the drawings. In schematic views, each of which is in longitudinal section:

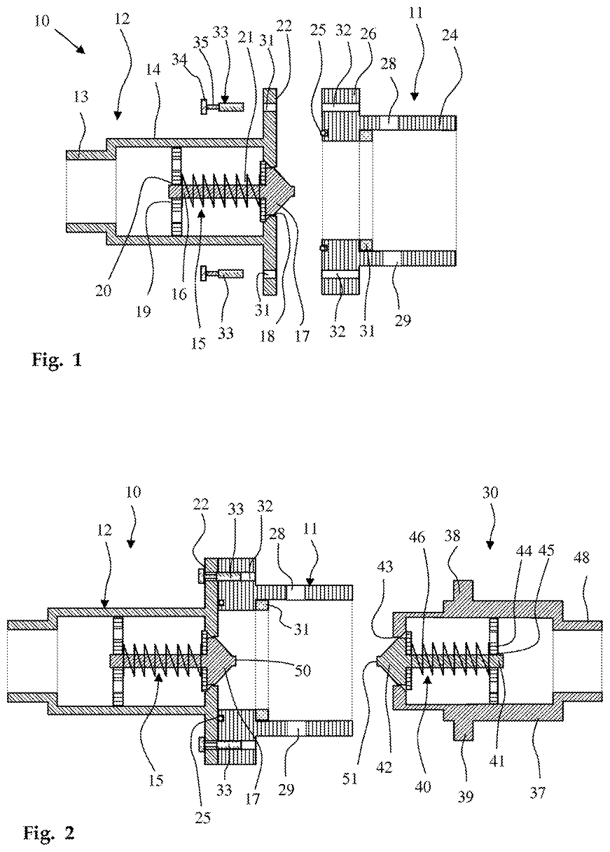

FIG. 1: shows the mutually separate components of a coupling socket of a coupling according to the invention,

FIG. 2: shows the assembled coupling socket and the coupling connector of the coupling from FIG. 1 in the uncoupled state,

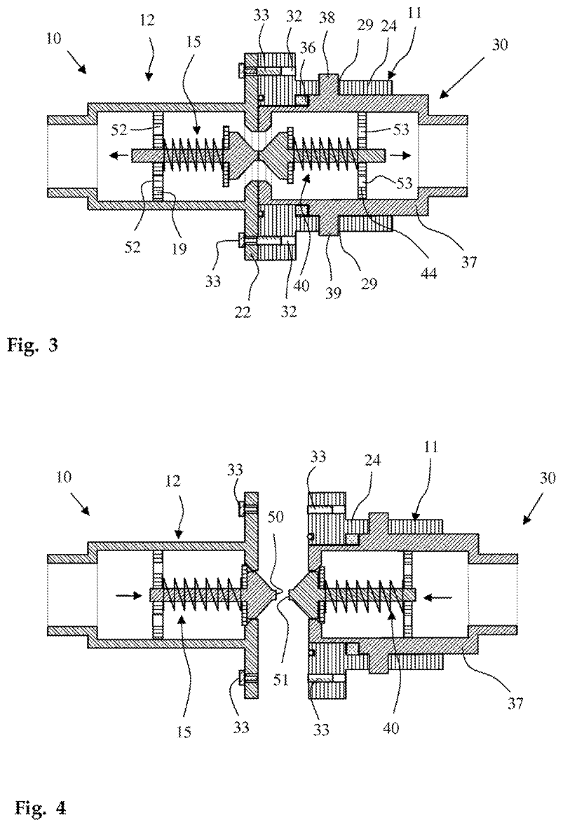

FIG. 3: shows the coupling from FIG. 1 and FIG. 2 in the closed state,

FIG. 4: shows the coupling from FIGS. 1 to 3 after an event which triggers the separation safeguard,

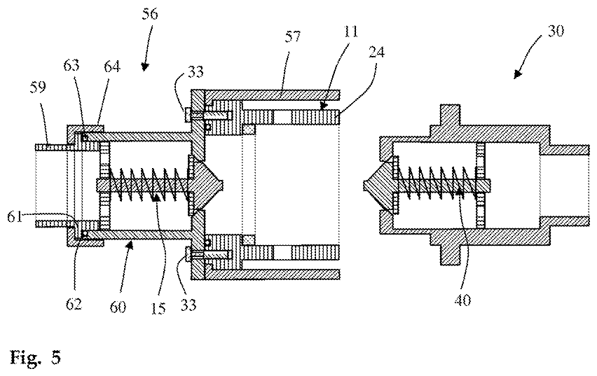

FIG. 5: shows a coupling according to the invention in another embodiment.

The coupling shown in FIGS. 1 to 4, which is designed as a quick action coupling, has a coupling socket 10 with a front section 11 and a rear section 12, which can be connected to said front section. The rear section 12, which is equipped with a connection stub 13 for connection to a line (not shown here) for a cryogenic medium, e.g. a line for liquid nitrogen, has a housing 14, in the interior of which a check valve 15 is arranged. The check valve 15 comprises a closure body 16 having a closing disk 17, which nonpositively closes an outlet 18 of the rear section 12 in a gastight manner under the action of a compression spring 21 when the coupling is open. The compression spring 21 extends radially around the outside of the closure body 16, between the closing disk 17 and a valve seat 19, which is mounted in a fixed manner in the interior of the housing 14 and has a central hole 20, through which the closure body 16 is passed with a limited ability for axial movement. There is a flange 22 on the opposite end of the housing 14 from the connection stub 13 to allow connection to the front section 11.

The front section 11 of the coupling socket 10 comprises a housing 24, which, at its end facing the rear section 12, has a flange 26 that is equipped with a PTFE sealing ring 25 and, for example, is welded to the housing 24. Connecting elements for fixed but releasable connection to a coupling connector 30 of the coupling are arranged on the front part of the front section 11; in the illustrative embodiment, these are slots 28, 29 of a bayonet joint. Another sealing ring 31 made of PTFE, which is arranged in the interior of the front section 11, is used to ensure gastightness after a connection to the coupling connector 30 has been established. For connection of the front section 11 and the rear section 12, a plurality of holes 32 provided with an internal thread is provided in the flange 26 of the front section 11, said holes being aligned parallel to the longitudinal axis of the front section 11 and preferably being arranged at uniform angular intervals. In a manner corresponding thereto, unthreaded holes 31, the diameters of which are slightly greater than that of the holes 32, are arranged in the flange 22 of the rear section 12. To fasten the sections 11, 12 to one another in the illustrative embodiment, use is made of screws 33, which are provided in the region of the screw head 34 with a predetermined breaking point 35, which is, for example, a section of reduced strength, e.g. a section of reduced material thickness. The screws 33 are passed through the holes 31 in the rear section 12 and are screwed into the holes 32 in the front section 11, thereby fixing the two sections 11, 12 to one another. According to the invention, it is furthermore possible in a simple way, by exchanging the screws 33 for screws with a higher or lower tensile strength, to adapt the connection between the sections 11, 12 to the respective requirements as regards the maximum tensile stress to which the coupling should be exposed during normal operation.

The coupling socket 10, which is assembled from the coupling socket 10 and the coupling connector 30, is shown in FIG. 2.

The coupling connector 30, which is shown in FIG. 2, comprises a housing 37, which, to establish a firm but releasable rotary closure body connection to the coupling socket 10, is equipped with knobs 38, 39, which correspond to the slots 28, 29. As in the rear section 12 of the coupling socket 10, a check valve 40 is arranged in the interior of the coupling connector 30. Check valve is similar in construction to the check valve 15 of the coupling socket 10 and comprises a closure body 41 having a closing disk 42, which, in the state shown in FIG. 2, nonpositively closes an outlet 43 of the coupling connector 30 in a gastight manner under the action of a compression spring 46. The compression spring extends radially around the outside of the closure body 41, between the closing disk 42 and a valve seat 44, which is mounted in a fixed manner in the housing 37 and is provided with a central hole 45, through which the closure body is passed with a limited ability for axial movement. Furthermore, the housing 37 has a connection stub 48 for connection to a line (not shown here) for a cryogenic medium.

The coupling is shown in the correctly coupled state in FIG. 3. In this state, the knobs 38, 39 of the bayonet joint are in engagement with the corresponding slots 28, and in this way establish a firm connection between the coupling parts 10, 30. Other methods of assembling and connecting the coupling socket and the coupling connector are furthermore likewise within the scope of the invention, such as the connection, described in more detail in DE 195 16 029 C1, by means of a union nut. On their mutually facing sides, the closing disks 17, 42 are provided with tappets 50, 51, which are pressed against one another when the coupling socket 10 and the coupling connector 30 are assembled and, during this process, move the closure bodies 16, 41 into their respective open state against the action of the spring force of the compression springs 21, 46, as indicated by arrows in FIG. 3. A flow path between the interiors of the coupling socket 10 and the coupling connector 30 is thereby simultaneously opened up in the region of the outlets 18, 43. In order to create a flow connection in the direction of the connection stubs 13, 48, respective through flow openings 52, 53 are provided in the valve seats 19, 44 arranged in the interior of the coupling socket 10 and the coupling connector 30. In the region of the connection, the housing 37 of the coupling connector and the housing 24 of the front section 11 of the coupling socket 10 overlap radially. Here, a thermally insulated embodiment of the housings 24, 37, e.g. by means of an annular vacuum chamber, effectively prevents icing up of the coupling as cryogenic medium flows through.

In FIG. 4, a coupling is shown after the occurrence of an event which triggers the separation safeguard. Here, “an event which triggers the separation safeguard” is understood to mean an event in which an axial tensile force that is greater than the tensile strength of the predetermined breaking points 35 of the screws 33 acts on the coupling. In this case, the screws 33 are destroyed, and the rear section 12 of the coupling socket 10 separates from the front section 11, which remains firmly connected to the coupling connector 30 by the bayonet joint, as before. In this case, the contact between the tappets 50, 51 of the closure bodies 16, 41 of the check valves 15, 40 is lost, and the check valves 15, 40 move automatically into their closed position under the action of the compression springs 21, 46 (as indicated by arrows in FIG. 4); the flow connection between the rear section 12 of the coupling socket 10 and the coupling connector 30 is closed. This is an effective way of preventing the coupling or part of the line breaking and the cryogenic medium conveyed through the line escaping into the environment in an uncontrolled manner if an event of this kind occurs. The remains of the screws 33 are removed, and the two sections 11, 12 of the coupling socket 10 can be reassembled easily with new screws 33.

The embodiment, shown in FIG. 5, of a coupling according to the invention differs from the coupling shown in FIGS. 1 to 4 only in having additional elements on the coupling socket 56. The coupling connector 30 is identical and is therefore provided with the same reference sign. Elements of the coupling socket 56 which have the same effect as elements of the coupling socket 10 are furthermore denoted by the same reference sign.

The coupling socket 56 is equipped with a shield 57 in the form of a sleeve, which extends concentrically around the front section 11 of the coupling socket 56 in order to protect the parts of the housing 24 of the front section 11 in the event of mechanical effects, e.g. if the coupling socket 56 falls down after emergency opening of the coupling. The shield 57 prevents damage to the front section 11 and in this way allows rapid reestablishment of the coupling connection after emergency opening.

The coupling socket 10 is connected to a line (not shown here) for a cryogenic medium, e.g. by welding or by a threaded joint. Although conventional lines for cryogenic media are usually of flexible design, they can twist upon themselves only with difficulty. Since the bayonet joint shown here requires a quarter turn of the two coupling parts 10, 30 relative to one another, the coupling socket is equipped with a connection stub 59 arranged rotatably on a housing 60 of the coupling socket 56, instead of a connection stub 13 mounted in a fixed manner on the housing or formed integrally therewith, as on the coupling shown in FIGS. 1 to 4. The connection stub 59, which is preferably connected in a fixed manner, e.g. by welding, to a line (not shown here) for a cryogenic medium has an encircling projection 61, by means of which the connection stub is supported by the opposite end 62 of the housing 60 from the coupling connector 30. In order to ensure gastightness, a sealing ring 63 made of PTFE is provided in a groove on the end 62. To prevent unintentional release of the connection stub 59 from the housing 40, it is fixed axially by means of a union nut 64 engaging behind the projection 61, but in such a way that rotatability of the connection stub 59 relative to the housing 60 is maintained.

### LIST OF REFERENCE SIGNS

10. coupling socket

11. front section

12. rear section

13. connection stub

14. housing (of the rear section)

15. check valve

16. closure body

17. closing disk

18. outlet

19. valve seat

20. central hole

21. compression spring

22. flange

23.

24. housing (of the front section)

25. sealing ring

26. flange

27.

28. slot

29. slot

30. coupling connector

31. hole

32. hole

33. screw

34. screw head

35. predetermined breaking point

36. sealing ring

37. housing (of the coupling connector)

38. knob

39. knob

40. check valve

41. closure body

42. closing disk

43. outlet

44. valve seat

45. central hole

46. compression spring

47.

48. connection stub

49.

50. tappet

51. tappet

52. through flow opening

53. through flow opening

54.

55.

56. coupling socket

57. shield

58.

59. connection stub

60. housing

61. projection

62. end

63. sealing ring

64. union nut

1. A coupling for cryogenic liquefied media for connecting fluid-carrying lines, having a coupling socket and a coupling connector, which are each equipped with a check valve, which, in the uncoupled state, seals off a through flow opening, arranged in the respective coupling part against the penetration of ambient air but automatically opens it during connection, wherein the coupling socket comprises a front section, having means for connection to the coupling connector, and a rear section, having the check valve, and the front section is connected to the rear section firmly but in a manner which allows release when a predetermined tensile stress is applied,
wherein the front section is connected to the rear section by means of connecting means that can be connected firmly to the front section and the rear section and each have a predetermined breaking point.

2. The coupling as claimed in claim 1, wherein the front section is connected to the rear section by means of screws which have a predetermined breaking point, which are passed through holes in a flange of a section of the coupling socket and which are screwed into internally threaded holes in a flange of the other section of the coupling socket.

3. The coupling as claimed in claim 1, wherein the means for connecting the front section to the coupling connector comprises a bayonet joint or a screwed joint.

4. The coupling as claimed in claim 1, wherein the check valve of the coupling connector and/or the check valve of the coupling socket are/is each equipped with an axially movable closing body, which can be moved counter to the action of a restoring force from a closed state, in which it seals off the through flow opening of the respective coupling part, into an open state, in which it exposes the through flow opening, wherein the closing bodies are configured in such a way that, during the connection of the coupling socket to the coupling connector, they move each other into the respective open state, exposing a flow path between the connected lines, but, during the separation of the coupling socket from the coupling connector or during the separation of the rear section from the front section of the coupling socket, they move automatically into their closed state.

5. The coupling as claimed in claim 1, wherein a sealing element, e.g. a sealing ring, is arranged on the front section and/or the rear section of the coupling socket, to establish a gastight connection to the respective other section.

6. The coupling as claimed in claim 1, wherein the front section of the coupling socket is equipped with a shield to protect the coupling socket from mechanical effects.

7. The coupling as claimed in claim 1, wherein the coupling socket is rotatably connected to a line for a cryogenic medium.
